(19) United States
(12) Patent Application Publication
(10) Pub. No.: US 2023/0319491 A1
(43) Pub. Date: Oct. 5, 2023

(54) WEARABLE DEVICE COVER WITH COMMUNICATION COIL

(71) Applicant: Cochlear Limited, Macquarie University, NSW (AU)

(72) Inventors: Jan VERMEIREN, Boechout (BE); Koen Erik VAN DEN HEUVEL, Hove (AU)

(21) Appl. No.: 18/041,312

(22) PCT Filed: Aug. 18, 2021
(86) PCT No.: PCT/IB2021/057591

§ 371 Date: Feb. 10, 2023

Related U.S. Application Data
(60) Provisional application No. 63/067,380, filed on Aug. 19, 2020.

(51) Int. Cl. H04R 25/00

(52) U.S. Cl. CPC H04R 25/55; H04R 25/65; H04R 2225/51

(57) ABSTRACT

An apparatus includes a removable cover for an ear-worn wearable device, with the removable cover including a communication coil. The cover can locate the communication coil proximate an implanted coil for communication. In an implementation, the cover is a cover for a behind-the-ear sound processor having a coil that communicates with an implanted coil of a cochlear implant.

### BACKGROUND

Medical devices have provided a wide range of therapeutic benefits to recipients over recent decades. Medical devices can include internal or implantable components/devices, external or wearable components/devices, or combinations thereof (e.g., a device having an external component communicating with an implantable component). Medical devices, such as traditional hearing aids, partially or fully-implantable hearing prostheses (e.g., bone conduction devices, mechanical stimulators, cochlear implants, etc.), pacemakers, defibrillators, functional electrical stimulation devices, and other medical devices, have been successful in performing lifesaving and/or lifestyle enhancement functions and/or recipient monitoring for a number of years.

The types of medical devices and the ranges of functions performed thereby have increased over the years. For example, many medical devices, sometimes referred to as “implantable medical devices,” now often include one or more instruments, apparatus, sensors, processors, controllers or other functional mechanical or electrical components that are permanently or temporarily implanted in a recipient. These functional devices are typically used to diagnose, prevent, monitor, treat, or manage a disease/injury or symptom thereof, or to investigate, replace or modify the anatomy or a physiological process. Many of these functional devices utilize power and/or data received from external devices that are part of, or operate in conjunction with, implantable components.

### SUMMARY

In an example, there is an apparatus comprising: a removable cover for an ear-worn wearable device, wherein the removable cover includes a communication coil. In another example, there is a method comprising selecting a cover having a communication coil and coupling the cover to a wearable device. In a further example there is a system comprising: a wearable device; and a cover removably coupled to the wearable device, the cover having a communication coil in electrical communication with the wearable device.

### BRIEF DESCRIPTION OF THE DRAWINGS

The same number represents the same element or same type of element in all drawings.

FIGS. 1, which is made up of FIGS. 1A, 1B, and 1C, illustrates an example apparatus that includes a wearable device and a removable cover for the wearable device.

FIG. 1A illustrates the cover being coupled to the wearable device.

FIG. 1B illustrates the combined cover and wearable device being placed on a recipient’s ear with respect to an implanted coil of an implanted medical device of the recipient.

FIG. 1C illustrates a combined cover and the wearable device being worn on the recipient’s ear, with a communication coil of the cover being disposed proximate the implanted coil based on a position of the communication coil in the cover.

FIGS. 2, which is made up of FIGS. 2A, 2B, and 2C, illustrates an implementation of a cover that couples at a front of a wearable device.

FIG. 2A illustrates a perspective view of the cover being coupled at the front of the wearable device.

FIG. 2B illustrates a front view of the cover of FIG. 2A.

FIG. 2C illustrates a rear view of the cover of FIG. 2A.

FIG. 3 illustrates a perspective view of the cover of FIGS. 2 relative to an implantable device having a coil.

FIG. 4 illustrates a perspective view of a cover having a communication coil disposed proximate an upper portion of the cover.

FIG. 5 illustrates a cover having a coil with a coil shape that substantially mimics a cover profile shape of the cover.

FIGS. 6, which is made up of FIGS. 6A, 6B, and 6C, illustrates an example implementation of the cover having a coil disposed on a flexible printed circuit board.

FIG. 6A illustrates a perspective view of the cover.

FIG. 6B illustrates a top view of the cover of FIG. 6A.

FIG. 6C illustrates a cutaway view of the cover taken along the line C-C of FIG. 6B.

FIGS. 7, which is made up of FIGS. 7A, 7B, and 7C, illustrates an example implementation of the cover having a wire connecting the communication coil to one or more electrical contacts

FIG. 7A illustrates a perspective view of the cover.

FIG. 7B illustrates a top view of the cover of FIG. 7A.

FIG. 7C illustrates a cutaway view of the cover of FIG. 7B taken along the line C-C of FIG. 7B.

FIG. 8 illustrates a wearable device having a recessed portion configured to receive the cover.

FIG. 9 illustrates an example device having multiple coils.

FIGS. 10, which is made up of FIG. 10A and FIG. 10B, illustrates a method.

FIG. 11 illustrates a functional block diagram of an implantable stimulator system that can benefit from the technologies described herein.

FIG. 12 illustrates a cochlear implant system that can benefit from use of the technologies disclosed herein.

FIG. 13 illustrates a retinal prosthesis system that comprises an external device, a retinal prosthesis, and a mobile computing device.

### DETAILED DESCRIPTION

Disclosed technology includes implementations of a wearable device cover that locates a communication coil proximate another coil for communication. Disclosed technology includes aligning a coil of a wearable device (e.g., a behind-the-ear sound processor) with an implanted coil (e.g., of a cochlear implant) of an implanted medical device. While magnets are traditionally used to align external and implanted coils, not all implants have retention magnets (e.g. for reasons of MRI compatibility) usable for such purposes. Further, magnets in external devices can add bulk. Disclosed techniques can be used to align implanted and external coils so that an implant and an external wearable medical device are able to effectively and efficiently communicate with each other via their coils without the need for magnets.

A coil of an external device can be positioned or positionable (e.g. in the case where the position of the coil relative to the cover is adjustable) relative to the cover such that the coil is able to appropriately align with an implant coil so that the external device and the implant are able to communicate with each other via their respective coils. The cover can be coupled to the external device (e.g., a behind-the-ear sound processor) in a way that communicatively connects the coil of the cover to the wearable device. For example, pins extending from the cover can couple with ports on an outer surface of the wearable device. Placing the contacts on an inside of the cover and on an outside of the wearable device can ease the action of adding the cover to the wearable device while reducing risk of damaging the electrical connector. Different kinds of covers can be designed to accommodate different possible implant locations and ear sides to improve coupling between external and implanted coils and ensure proper coil alignment. For example, the external coil can be disposed in a location of the cover to communicate with an implanted coil implanted behind the recipient’s pinna when the cover is coupled to the wearable device and the wearable device is worn on the recipient’s ear. Thus, implementations can provide an alternative to traditional magnet-located coil implementations and be able to communicate with magnetless implantable devices.

The external coil can be positioned with respect to the cover in any of a variety of ways. For example, the external coil can be permanently integrated into the material of the cover, such as via an overmolding process or by entirely or partially embedding the coil in the material of the cover. In another example, the coil is configured to be repositioned to various locations on the cover. For instance, the coil can be disposed on a flexible substrate (e.g., a flexible printed circuit board) and be configured to be repositioned to various areas of the cover. The coil can be a copper wound coil. The cover can take any of a variety of different appearances, such as by being opaque or at least partially transparent to visible light.

An implantable device can be implanted in a recipient and have an implanted coil integrated in an RF-transparent housing. One or both of the implanted coil and medical device can be located posterior to the recipient’s ear canal in the mastoid bone with an implanted coil under the recipient’s skin in the area that is shadowed by the recipient’s pinna. The implanted coil position can vary for different recipients based on their anatomy and implanting clinician’s preferences. After surgery, the implant coil position is determined and a suitable cover is chosen to match the external coil’s position relative to the implanted coil. Proper positioning of the coils can optimize radiofrequency efficiency and improve battery life and integrity of a communicated data signal of the communicating devices. As an example, during a fitting session, a clinician determines the position of the implant coil or a suitable position of an external coil. For instance, the clinician may try fitting multiple different covers, by physically manipulating a cover, or by placing a template having multiple different coils pre-installed. The clinician can measure connection strengths or distances between the coils to determine an appropriate cover for the recipient. The appropriate cover may be a pre-made cover or a custom manufactured cover configured to meet the needs of the particular recipient.

In an example, software is used to connect with the wearable device and test a connection strength with an implanted component. A screen of a fitting interface, can provide an indication of how well the external device is connecting with the implant. There can be an interactive system where one can switch covers and see immediate feedback on how well the device is coupling. A clinician can place an initial cover on the wearable device and place the wearable device on the recipient. The clinician can then physically manipulate the device up, down, or while monitoring a connection strength in order to determine whether a different cover would be more suitable for the recipient. If so, then the cover can be switched.

### Example Apparatus

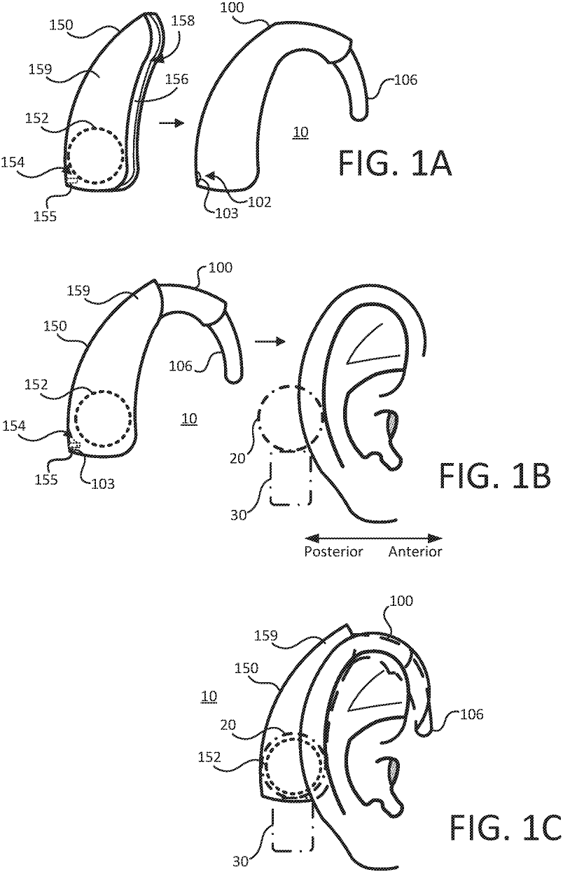

FIGS. 1, which is made up of FIGS. 1A, 1B, and 1C, illustrates an example apparatus 10 that includes a wearable device 100 and a removable cover 150 for the wearable device 100. FIG. 1A shows the cover 150 being coupled to the wearable device 100. FIG. 1B shows the combined cover 150 and wearable device 100 being placed on a recipient’s ear with respect to an implanted coil 20 of an implanted device 30 of the recipient. Further, with the cover 150 being removably coupled to the wearable device 100, a communication coil 152 of the cover 150 is in electrical communication with the wearable device 100. FIG. 1C shows the combined cover 150 and the wearable device 100 worn on the recipient’s ear, with a communication coil 152 of the cover 150 being disposed proximate the implanted coil 20 based on a position of the communication coil 152 in the cover 150. Where the wearable device 100 is configured to be worn with respect to a recipient’s ear, the wearable device 100 can be referred to as an ear-worn device or an ear-worn wearable device.

In an example, the implantable device 30 is an implanted medical device, such as a cochlear implant or a tinnitus implant, among other devices. The implantable device 30 can be configured to be implanted proximate a mastoid cavity of a recipient.

The implanted coil 20 can be a component configured to receive or transmit a signal, such as via an inductive arrangement formed by multiple turns of wire. In examples, in addition to or instead of a coil, other arrangements can be used with examples described herein, such as an antenna or capacitive plates. In an example, the implanted coil 20 lacks a magnet. In an example, the implanted coil has an outer diameter of approximately 30 mm.

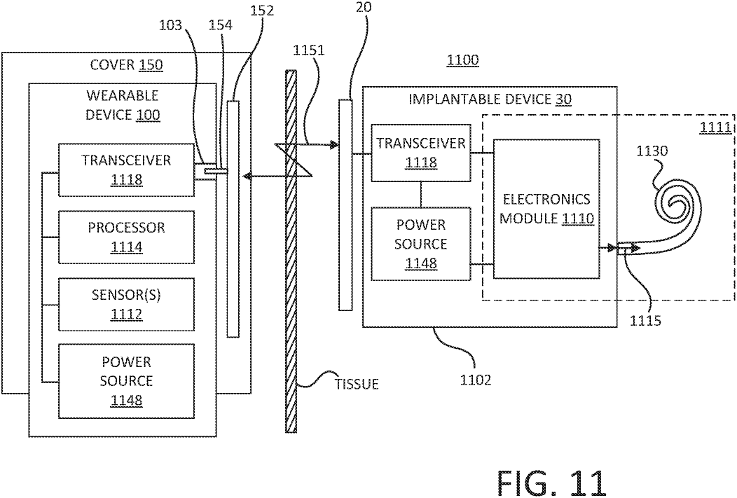

The wearable device 100 is a device configured to be worn by a recipient and being configured to communicate, using the communication coil 152, with another device. The wearable device 100 can be configured for any of a variety of functions, such as external sensing, charging, or processing for an implanted device. The wearable device 100 can take any of a variety of forms. In the illustrated example, the wearable device 100 is arranged as a behind-the-ear device, such as for a hearing aid or an auditory prosthesis. Example components and features of a wearable device 100 are described in relation to FIGS. 11-13, infra.

In examples, the wearable device 100 can have a sidedness. For example, the wearable device 100 can be a left side wearable device 100 or right side wearable device 100 and can be configured for use with a particular respective left-sided cover 150 or right-sided cover 150. In an example implementation, the wearable device 100 can reconfigure itself such that a single wearable device 100 can be used as a left or right side wearable device.

The wearable device 100 includes a wearable device electrical contact region 102 having at least one wearable device electrical contact 103. In the illustrated example, the wearable device electrical contact region 102 is disposed at a back surface of the wearable device 100. In other examples the wearable device electrical contact region 102 can be disposed at a front surface of the wearable device 100 or in another location. In an implementation, the wearable device electrical contact 103 is formed as a receptacle to receive a cover electrical contact 155 of the cover 150, such as a pin. As a result, when the cover 150 is coupled to the wearable device 100, the pin is disposed in the receptacle thereby forming an electrical connection between the wearable device 100 and the cover 150. Other electrical connection arrangements can be used.

As illustrated, the wearable device 100 includes a retainer 106. The retainer 106 is a component or portion of the wearable device 100 configured to permit the wearable device 100 to be wearably retained by the recipient. In the illustrated example, the retainer 106 is in the form of an ear hook. The ear hook can be a curved component or portion of housing extending from a main body of the wearable device 100. The curve of the ear hook 106 is configured to rest along a portion of the top of the recipient’s pinna adjacent the side of the recipient’s head. When the ear hook 106 rests along a portion of the top of the recipient’s pinna adj acent the side of the recipient’s head, the wearable device 100 can be hung on the recipient’s ear, thereby wearably retaining the wearable device 100 on the recipient’s ear. In an example, the retainer 106 is a clip configured to clip onto a portion of the recipient’s body, clothing, or hair. In an example, the retainer 106 is a component configured to be inserted in the recipient’s ear (e.g., into the pinna or the ear canal) and retain the device by a fit therein. In an example, the wearable device 100 is arranged as a pair of eyeglasses, with the retainer 106 being the temples (e.g., a curved portion of the temples).

The removable cover 150 is a cover for the wearable device 100. The cover 150 can be configured to be removably coupled to the wearable device 100 by a user. The cover 150 can be a component that encapsulates at least some the internals of the wearable device 100. In some examples, removal of the cover 150 exposes one or more user-accessible batteries or microphones. The cover 150 can completely or partially cover the wearable device 100. In some examples, the cover 150 is implemented as a removable panel of the wearable device 100. In some examples, the cover 150 is configured as at least a portion of a housing of the wearable device 100. In some examples, the cover 150 is configured to be disposed over an existing housing of the wearable device 100. The cover 150 can be configured as a protective shell for the wearable device 100. In some examples, the cover 150 includes one or more features (e.g., gaskets or seals) to resist entry of liquids or dust to a portion of the wearable device 100 covered by the cover 150. The cover 150 can be constructed from any of a variety of different materials, such as plastics, rubbers, metals, other materials, or combinations thereof. In some examples, the cover 150 is constructed from a same material as the wearable device 100. In some examples, the cover 150 has different physical shapes that match the recipient’s outer ear anatomy.

The cover 150 can be substantially formfitting to an exterior surface of at least a portion of the wearable device 100. The cover 150 can conform to a shape of the wearable device 100. For example, the cover 150 can conform to a shape of the portion of the wearable device 100 that the cover 150 covers. The cover 150 can be a shell that covers the wearable device 100. The cover 150 can be configured to not interfere with use of the wearable device 100 by the recipient when the cover 150 is properly coupled with the wearable device 100.

The cover 150 can couple to the wearable device 100 using any of a variety of techniques. The cover 150 can be configured to snap, stretch, clip, or otherwise couple with the wearable device 100. In some examples, the cover 150 is or includes pliable or elastic components that stretch or shape over the wearable device 100. In examples, the cover 150 can be configured to be pliable so as to deform and clip into retention areas of the wearable device 100 to retain the cover. The cover 150 can be configured to be locked or unlocked from the wearable device with a locking screw, tab, or latch. The cover 150 can be configured to be coupled to and removed from the wearable device 100 by a user. The cover 150 can be configured to be coupled to and removed from the wearable device 100 by a user repeatedly without substantially damaging the cover 150 or the wearable device 100. In some examples, the cover 150 is configured to be non-removable or replaceable by the user. A special tool or coupling configuration can be used.

The illustrated cover 150 includes a communication coil 152. The illustrated cover 150 further includes a cover electrical contact region 154. The illustrated cover 150 includes one or more cover electrical contacts 155 within the cover electrical contact region 154. The illustrated cover 150 further defines an inside surface 156, a concavity 158, and an outside surface 159. In examples, the cover 150 can include a magnet configured to facilitate locating the cover 150 with respect to the implanted coil 20. In other examples, the cover 150 lacks a magnet. The illustrated cover 150 defines a concavity 158. The wearable device 100 is at least partially received in the concavity 158 when the cover 150 is coupled to the wearable device 100. The surface of the concavity 158 can include the inside surface 156.

The communication coil 152 can be a component configured to receive or transmit a signal, such as via an inductive arrangement formed by multiple turns of wire. In examples, in addition to or instead of a coil, other arrangements can be used with examples described herein, such as an antenna or capacitive plates. The coil 152 can take any of a variety of shapes. For instance, the communication coil 152 can take the form of a wound copper coil. In some examples, the coil 152 includes a substrate to which the turns of wire are affixed or in which the turns of wire are disposed. In some examples, the cover 150 can act as such a substrate.

The communication coil 152 can be positioned with respect to the cover 150 in any of a variety of ways. For example, the communication coil 152 can be permanently coupled to the cover 150 such that the communication coil 152 is not readily separable from the cover 150. In an example, the communication coil 152 is permanently coupled to the cover 150 such that the coil 152 cannot be removed without significantly damaging one or both of the cover 150 and the coil 152. In some examples, the coil 152 is permanently coupled to the cover 150 by the coil being embedded in the cover 150 during a manufacturing process. The coil 152 can be buried in the cover 150 during manufacturing. In some examples, the coil 152 is coupled to the cover 150 with an adhesive, epoxy, or by the application of another material. In some examples, the coil 152 is permanently coupled to the cover 150 after a fitting process. For instance, the coil 152 may be temporarily coupled to the cover 150, then once a desired location for the coil 152 is determined, the coil 152 can be permanently affixed to the cover 150 (e.g., using an adhesive).

In at least some examples, the coil 152 is configured to be readily repositioned with respect to the cover 150. For example, the coil 152 and the cover 150 can have compatible features that facilitate coupling. In an example, the cover 150 includes a region covered with touch fasteners, hook-and-loop fasteners, or reclosable fasteners. The coil 152 includes compatible fasteners, thereby enabling the coil 152 to be readily coupled to and uncoupled from the region of the cover 150. In an example, the coil 152 or the cover 150 includes or is coupled to one or more fasteners to facilitate coupling, such as clips, tabs, slots, or other retention features.

In the illustrated example, the coil 152 has a substantially circular shape. The communication coil 152 and the implanted coil 20 of the implanted device 30 can be disposed in relation to each other (e.g., in a substantially coaxial relationship), with the position of the communication coil 152 in the cover 150 facilitating orienting the coil 152 in relation to the implanted coil 20.

The cover electrical contact region 154 is an area of the cover 150 or the coil 152 being configured to place the cover 150 or the coil 152 in electrical contact with another device, such as the wearable device 100. In an example, the cover electrical contact region 154 includes one or more electrical contacts 155 (also referred to as cover electrical contacts 155) configured to place the communication coil 152 in electrical communication with the wearable device 100. The one or more electrical contacts 155 can include at least two pins electrically coupled to the communication coil 152. The pins can be rigid or movable (e.g., formed as pogo pins). When the cover 150 is coupled to the wearable device 100, the at least one cover electrical contact 155 and the at least one wearable device electrical contact 103 form a connection with each other, thereby placing the communication coil 152 in electrical communication with the wearable device 100.

The inside surface 156 is the portion of the cover 150 disposed proximate the wearable device 100 when the removable cover 150 is coupled to the wearable device 100. The inside surface 156 or a portion thereof can be in direct contact with the wearable device 100 when the cover 150 is coupled to the wearable device 100. The cover electrical contact region 154 and its one or more electrical contacts 155 are disposed at the inside surface 156. Where the cover 150 includes a concavity 158, the inside surface 156 can be a surface within the concavity 158. The one or more electrical contacts 155 can be disposed at an inside surface 156 of the removable cover 150 within the concavity 158.

In the illustrated example, the removable cover 150 defines a concavity 158 configured receive the wearable device 100 when the removable cover 150 is coupled to the wearable device 100. The concavity 158 can be so configured by being sized and shaped to receive the wearable device 100. In examples, the cover 150 can elastically deform to accommodate the wearable device 100 being disposed in the concavity 158.

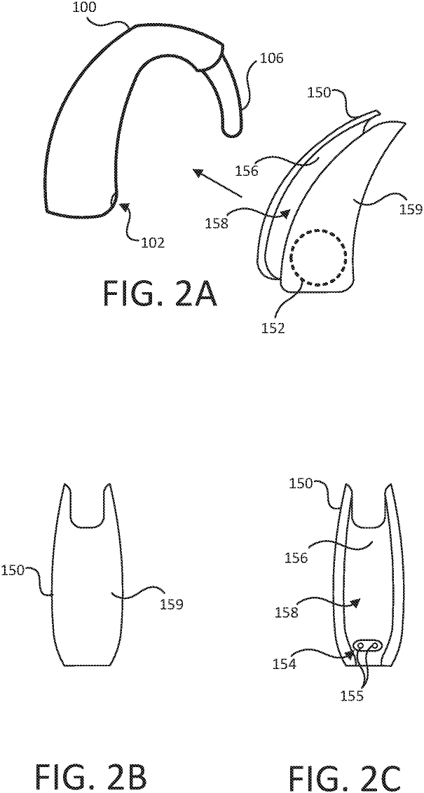

The illustrated configuration shows the cover 150 being a unitary piece that fits over the wearable device 100. The wearable device 100 can be coupled to the cover 150 such that the back of the wearable device 100 enters the concavity 158 first. In other implementations (e.g., the cover 150 of FIG. 2A), the wearable device 100 can be coupled to the cover 150 such that the front of the wearable device 100 enters the concavity 158 first. In further examples, the cover 150 can be sleeve or tubular structure such that fits over the wearable device 100. In some instances, the wearable device 100 is inserted into an opening defined by the cover 150 or the cover 150 is inserted into an opening or region defined by the wearable device 100. In some implementations, the cover 150 is formed from multiple different pieces that join together to cover the wearable device 100.

The outside surface 159 of the removable cover 150 can be a surface that is visible when the removable cover 150 is coupled to the wearable device 100. In some examples, the outside surface 159 includes ornamentation.

FIGS. 2, which is made up of FIGS. 2A, 2B, and 2C, illustrates an implementation of the cover 150 that is coupled at the front of the wearable device 100. FIG. 2A shows a perspective view of the cover 150 being coupled at a front of the wearable device 100. FIG. 2B shows a front view of the cover 150. FIG. 2C illustrates a rear view of the cover 150 that defines a concavity 158 in which the wearable device 100 can be received. In this example, the front of the cover 150 is disposed proximate the posterior portion of the recipient’s pinna and an opening of the concavity 158 is away from the recipient’s pinna when the cover 150 is coupled to the wearable device 100 and the wearable device 100 is worn on the recipient’s ear. This can be in contrast to the cover 150 of FIGS. 1, which illustrates the opening of the concavity 158 being proximate the posterior portion of the recipient’s pinna when the cover 150 is coupled to the wearable device 100 and the wearable device is worn on the recipient’s ear.

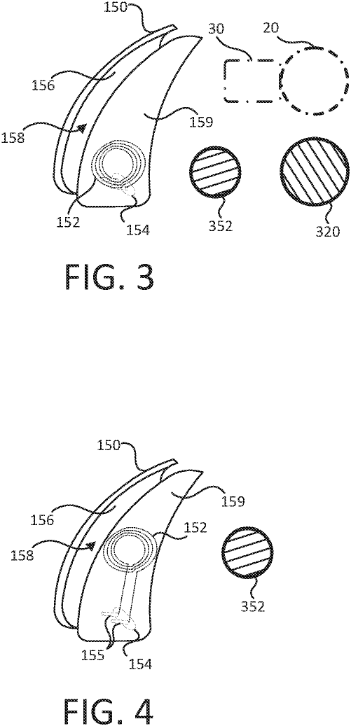

FIG. 3 illustrates a perspective view of the cover 150 of FIGS. 2 relative to an implantable device 30 having a coil 20. The illustrated cover 150 includes a coil 152 having a communication coil shape 352 that is substantially circular. The illustrated cover 150 has the coil 152 disposed proximate a bottom portion of the cover 150. The implanted coil 20 has an implantable coil shape 320 that is substantially circular.

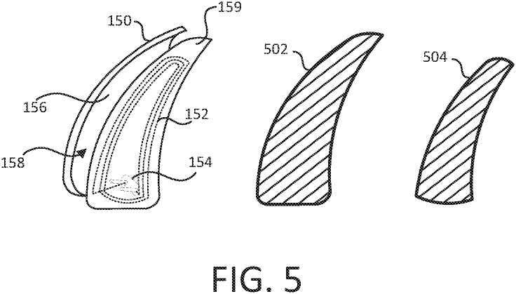

FIG. 4 illustrates a perspective view of a cover 150 having a communication coil 152 disposed proximate an upper portion of the cover 150. Like the coil 152 of FIG. 3, the coil 152 shown in FIG. 4 has a communication coil shape 352 that is substantially circular.

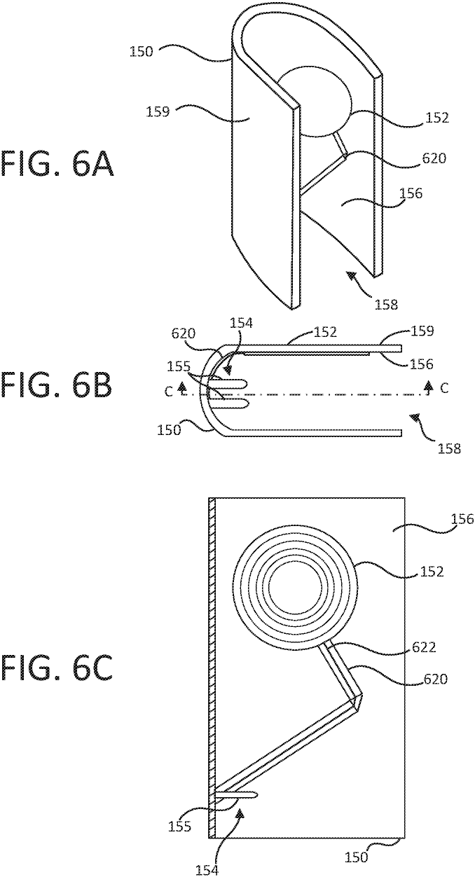

FIG. 5 illustrates a cover 150 having a coil 152 with a coil shape 504 that substantially mimics a cover profile shape 502 of the cover 150. In the illustrated example, the communication coil 152 has a coil shape 504 that is oblong and curved.

### Repositionable Coil

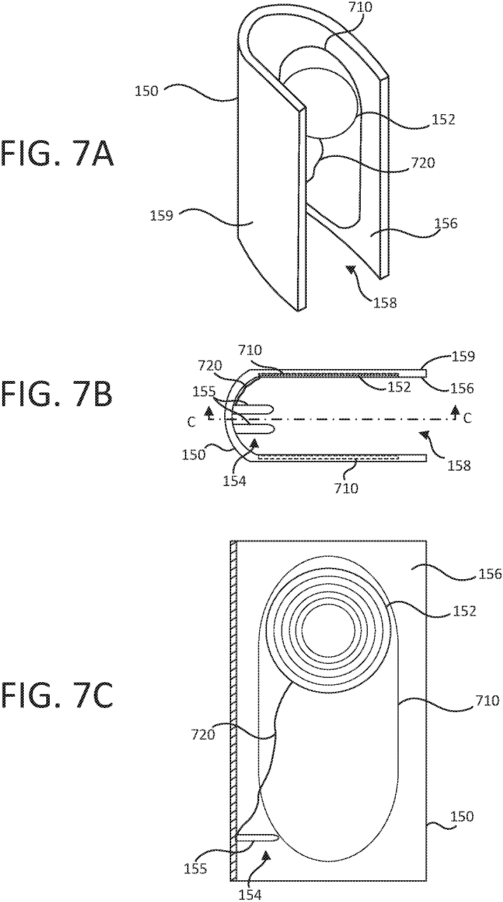

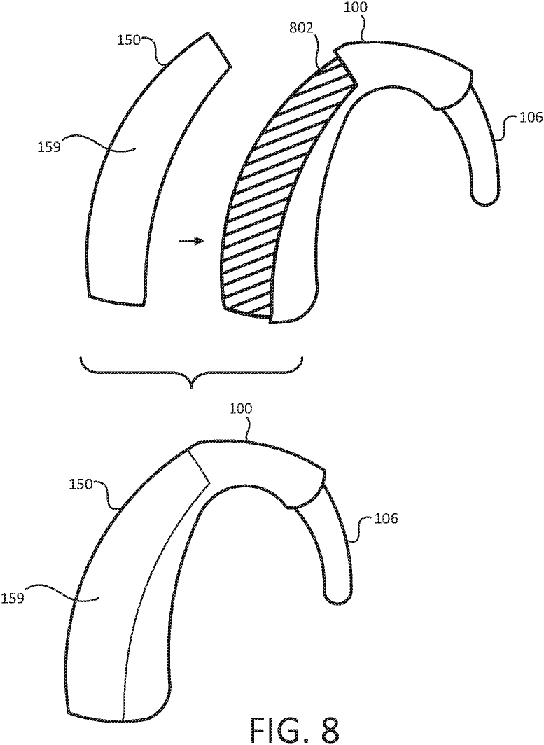

In some implementations, the communication coil 152 is configured to be repositioned in the cover 150. Examples of such implementations are shown in FIGS. 6 and FIGS. 7.

FIGS. 6, which is made up of FIGS. 6A, 6B, and 6C, illustrates an example implementation of the cover 150 where the communication coil 152 is disposed on a flexible printed circuit board 620. FIG. 6A illustrates a perspective view of the cover 150. FIG. 6B illustrates a top view of the cover 150 of FIG. 6A. FIG. 6C illustrates a cutaway view of the cover 150 of FIG. 6B taken along the line C-C of FIG. 6B. As illustrated, the communication coil 152 is disposed on a flexible printed circuit board 620. Further, the communication coil 152 is electrically coupled to the electrical contacts 155 of the cover 150 via one or more traces 622 also on the flexible printed circuit board 620. In other examples, the communication coil 152 can be electrically coupled to the electrical contacts 155 of the cover via one or more wires. The flexibility of the printed circuit board 620 and the connection with the electrical contacts 155 can facilitate moving the coil 152 to different locations at the cover 150, such as between left and right sides of the cover 150.

FIGS. 7, which is made up of FIGS. 7A, 7B, and 7C, illustrates an example implementation of the cover 150 having a wire 720 connecting the communication coil 152 to one or more electrical contacts 155. FIG. 7A illustrates a perspective view of the cover 150.

FIG. 7B illustrates a top view of the cover 150 of FIG. 7A. FIG. 7C illustrates a cutaway view of the cover 150 of FIG. 7B taken along the line C-C of FIG. 7B.

In the illustrated example, the cover 150 defines an indented area 710 within the inside surface 156 of the cover 150. The indented area 710 defines a region into which the coil 152 can be repositioned. The coil 152 can be configured to be repositioned within the indented area 710. In an example, the indented area 710 is so configured by being recessed to a depth such that the coil 152, when disposed in the indented area 710 does not extend out of the indented area 710. Such a configuration can prevent the coil 152 from jutting out to such an extent that the coil 152 interferes with the cover 150 coupling to the wearable device 100. In another example, the coil 152 is so configured by being configured to couple with one or more features in the indented area 710. For example, the coil 152 and the indented area 710 can have compatible fasteners (e.g., touch fasteners, hook-and-loop fasteners, or reclosable fasteners). In some examples, the indented area 710 is one or more holes or openings defined by and extending through the cover 150 in which the coil 152 can be disposed.

### Recessed Portion

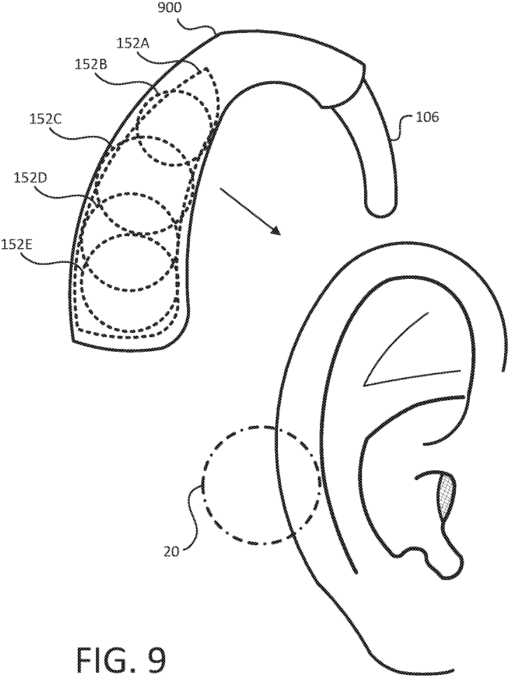

FIG. 8 illustrates a wearable device 100 having a recessed portion 802. The recessed portion 802 is configured to receive the cover 150. The recessed portion 802 can be configured such that, when the cover 150 is coupled with the wearable device 100, the resulting combination has a substantially smooth and continuous transition between the cover 150 and the wearable device 100. For instance, while there may be a minor seam or gap between the components, the discontinuity is relatively small.

### Multiple Coils

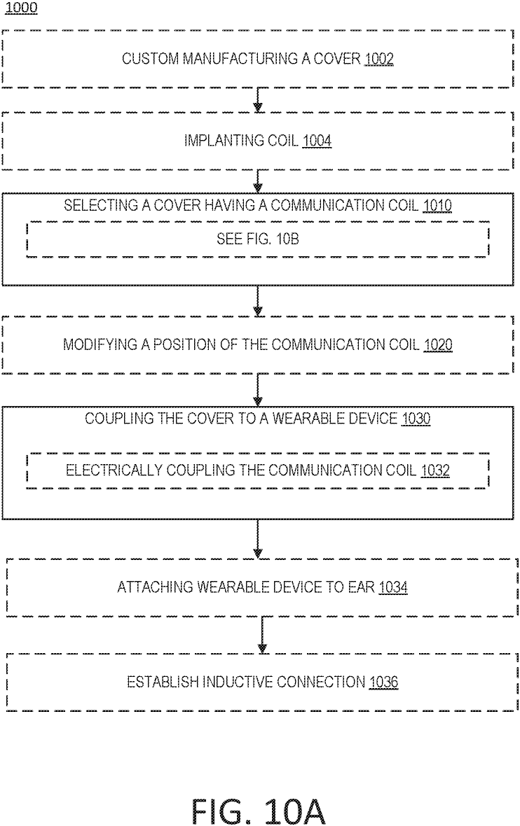

FIG. 9 illustrates an example device 900 having multiple coils 152A, 152B, 152C, 152D, and 152E. In some examples, the device 900 is configured as a wearable device 100 as described elsewhere herein. For instance, one or more coils 152 can be disposed in the wearable device directly without respect to a cover. In other examples, multiple coils 152 can be disposed in a cover 150. In some examples, a cover 150 can have multiple different coils 152 on both left and right sides. The cover 150 can have multiple different pins with a distinguishing on left or right coils and the device can be configured to select a suitable coil from among the different options.

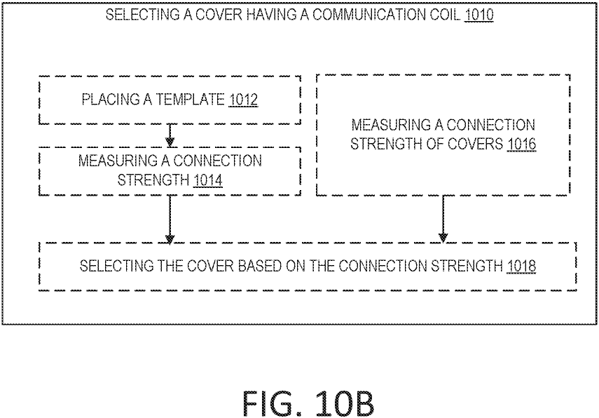

In some examples, the device 900 is a template 900 configured for use as part of a fitting process to determine what kind of coil configuration is suitable given the position of the implanted coil 20. For example, the template 900 can be worn on a recipient’s ear, a connection strength can be measured between one or more of the coils of the template 900 and an implanted coil 20, then a position of a coil 152 having a highest connection strength can be used to determine a position of a coil 152 in a cover 150. An example use of a template 900 is described in relation to operations 1012, 1014, and 1018 of FIG. 10B, below.

### Example Method

FIGS. 10, which is made up of FIG. 10A and FIG. 10B, illustrates a method 1000. The method 1000 can include various operations, including operations 1002, 1004, 1010, 1020, 1030, 1034, and 1036.

Operation 1002 includes custom manufacturing a cover 150 for the recipient. In some examples, the cover 150 is partially or wholly customized for a particular recipient. For example, measurements can be taken of the area where the cover 150 will be positioned and the cover 150 can be customized based on those measurements. For instance, where the cover 150 is for a wearable device 100, the cover 150 can be customized to match particular anatomy proximate the recipient’s ear to improve fit and comfort. In some examples the cover 150 is custom manufactured with respect to the positioning of the coil 152 with relative to the cover 150. In some examples, the custom manufacturing is based on results of the cover selection process of operation 1010, infra.

Operation 1004 can include implanting a coil 20 in a recipient. For example, the implanting can include forming a cavity in a mastoid bone of a recipient and implanting one or both of the implanted coil 20 and the implantable device 30 in a cavity formed in a mastoid bone of the recipient.

Operation 1010 can include selecting a cover 150 having a communication coil 152. In an example, the operation 1010 includes selecting a selected cover 150 from among a plurality of covers 150, wherein at least one of the plurality of covers 150 has a communication coil 152 in a different position than the selected cover 150. In an example, selecting the selected cover 150 from among a plurality of covers 150 based on a similarity between a shape of the communication coil 152 of the selected cover 150 and a shape of an implanted coil 20. The selecting can be further based on a location in which the implanted coil 20 is implanted. The cover 150 can be selected based on a cover 150 having a coil 152 that would be aligned with an implanted coil 20 of the recipient. As shown in FIG. 10B, operation 1010 can further include operations 1012, 1014, 1016, and 1018.

Operation 1012 includes placing a template 900. For example, the placing can include placing the template 900 proximate an ear of a recipient having an implanted coil 20. Following operation 1012, the flow can move to operation 1014, which includes measuring a connection strength 1014. In an example, the operation 1014 includes, for each respective coil 152 of a plurality of coils 152A, 152B, 152C, 152D, 152E of the template 900, measuring a connection strength between the respective coil 152 of the template 900 and the implanted coil 20. Following operation 1014, the flow of the method can move to operation 1018.

Operation 1016 can include measuring a connection strength of one or more covers 150. In an example, the operation 1016 includes, for each respective cover 150 of a plurality of covers 150, measuring a connection strength between a respective cover communication coil 152 of the respective cover 150 and the implanted coil 20.

Operation 1018 can include selecting a cover 150 based on the connection strength. For example, operation 1014 can result in multiple different connection strengths being obtained for the various coils 152 of the template 900. And operation 1016 can result in multiple different connection strengths being measured for different coils 152. In an example, the operation 1018 includes selecting the selected cover 150 based on the coil 152 of the template 900 associated with a highest measured communication strength. For instance, the selected cover 150 can have a coil 152 in a position similar to the position of the coil 152 of the template 900 associated with the highest measured communication strength.

Returning to FIG. 10A, operation 1020 includes modifying a position of the communication coil 152. As described above, certain covers 150 and coils 152 can be configured such that the coils 152 can be repositioned with respect to the cover 150. The position of the communication coil 152 can include uncoupling a coil 152 from a cover 150, repositioning the coil 152, and recoupling the coil 152 with the cover 150. In an example, the modifying the position is based on measured connection strengths between the coil 152 and the implanted coil 20. In a first position, the coil 152 can have a first connection strength that is lower than a second connection strength in a second position.

Operation 1030 includes coupling the cover 150 having the communication coil 152 to a wearable device 100. The coupling can include inserting a front, side, back, top, and/or bottom of the wearable device 100 into a concavity 158 of the cover 150. The coupling can include inserting the cover 150 into the wearable device 100. The coupling can include snapping the cover 150 to the wearable device 100, stretching the cover 150 over the wearable device 100, sliding the cover 150 over the wearable device 100, or clipping the cover 150 to the wearable device 100. In some examples, the operation 1030 includes elastically deforming the cover 150 or a portion thereof to fit the cover 150 to the wearable device 100. The operation 1030 can include locking the cover 150 to the wearable device 100 using a locking screw, tab, or latch.

In some examples, the operation 1030 includes operation 1032. Operation 1032 includes electrically coupling the communication coil 152. In an example, the electrical coupling includes electrically coupling a first cover 150 electrical contact of the cover 150 with a first wearable device electrical contact 103 of the wearable device 100 and electrically coupling 1032 a second cover 150 electrical contact of the cover 150 with a second wearable device electrical contact 103 of the wearable device 100. In some examples, physically attaching the cover 150 to the wearable device 100 is a same motion that electrically connects the communication coil 152 with the wearable device 100. In some examples, the electrical coupling occurs as a separate action from the physical coupling of the cover 150 and the wearable device 100.

Operation 1034 includes attaching a wearable device 100 to the ear. In an example, the operation 1034 includes attaching the wearable device 100 an ear of a recipient such that the communication coil 152 is disposed proximate an implanted coil 20. In an example, the attaching includes attaching 1034 the wearable device 100 to the ear of the recipient includes hanging the wearable device 100 from the ear of the recipient. The attaching can result in the communication coil 152 being disposed proximate the implanted coil 20 based on a position of the communication coil 152 in the cover 150. In some examples, the operation 1034 includes inserting the wearable device 100 at least partially into a pinna and/or ear canal of the recipient’s ear.

Operation 1036 includes establishing an inductive connection. The inductive connection can be an inductive connection between the coil 152 and the implanted coil 20. The inductive connection can be a connection between the wearable device 100 and the implanted device 30 via the respective coils 20, 152. The inductive connection can be used to unidirectionally or bidirectionally transmit one or both of power and data between the wearable device 100 and the implanted device 30 via the coils 20, 152.

### Example Devices

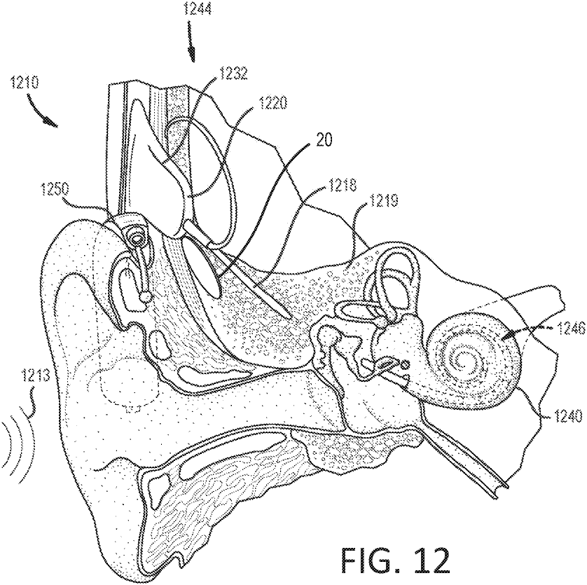

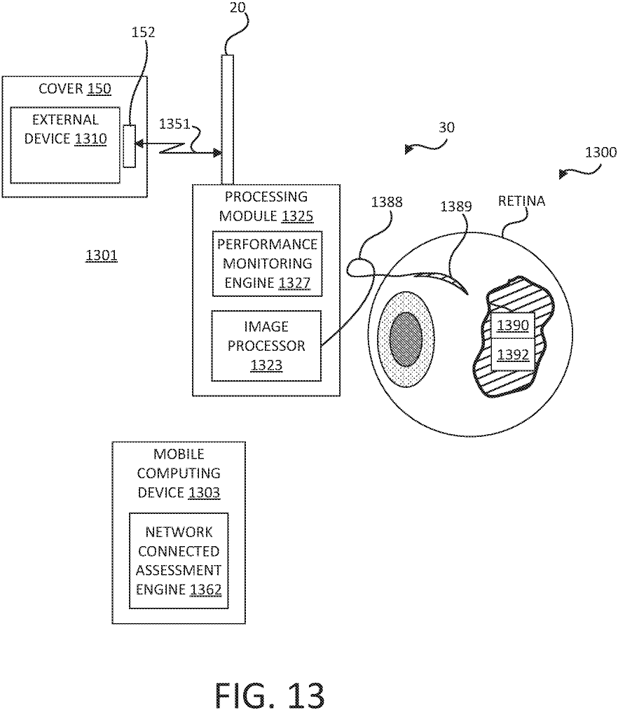

As previously described, the technology disclosed herein can be applied in any of a variety of circumstances and with a variety of different devices. Example devices that can benefit from technology disclosed herein are described in more detail in FIGS. 11-13, below. For example, the techniques described herein can be used with wearable medical devices, such as an implantable stimulation system as described in FIG. 11, a cochlear implant as described in FIG. 12, or a retinal prosthesis as described in FIG. 13. The technology can be applied to other medical devices, such as neurostimulators, cardiac pacemakers, cardiac defibrillators, sleep apnea management stimulators, seizure therapy stimulators, tinnitus management stimulators, and vestibular stimulation devices, as well as other medical devices that deliver stimulation to tissue. Further, technology described herein can also be applied to consumer devices. These different systems and devices can benefit from the technology described herein.

### Example Device - Implantable Stimulator System

FIG. 11 is a functional block diagram of an implantable stimulator system 1100 that can benefit from the technologies described herein. The implantable stimulator system 1100 includes the wearable device 100 acting as an external processor device and an implantable device 30 acting as an implanted stimulator device. In examples, the implantable device 30 is an implantable stimulator device configured to be implanted beneath a recipient’s tissue (e.g., skin). In examples, the implantable device 30 includes a biocompatible implantable housing 1102. Here, the wearable device 100 is configured to transcutaneously couple with the implantable device 30 via a wireless connection to provide additional functionality to the implantable device 30.

In the illustrated example, the wearable device 100 includes one or more sensors 1112, a processor 1114, a transceiver 1118, and a power source 1148. The one or more sensors 1112 can be one or more units configured to produce data based on sensed activities. In an example where the stimulation system 1100 is an auditory prosthesis system, the one or more sensors 1112 include sound input sensors, such as a microphone, an electrical input for an FM hearing system, other components for receiving sound input, or combinations thereof. Where the stimulation system 1100 is a visual prosthesis system, the one or more sensors 1112 can include one or more cameras or other visual sensors. Where the stimulation system 1100 is a cardiac stimulator, the one or more sensors 1112 can include cardiac monitors. The processor 1114 can be a component (e.g., a central processing unit) configured to control stimulation provided by the implantable device 30. The stimulation can be controlled based on data from the sensor 1112, a stimulation schedule, or other data. Where the stimulation system 1100 is an auditory prosthesis, the processor 1114 can be configured to convert sound signals received from the sensor(s) 1112 (e.g., acting as a sound input unit) into signals 1151. The transceiver 1118 is configured to send the signals 1151 in the form of power signals, data signals, combinations thereof (e.g., by interleaving the signals), or other signals. The transceiver 1118 can also be configured to receive power or data. Stimulation signals can be generated by the processor 1114 and transmitted, using the transceiver 1118, to the implantable device 30 for use in providing stimulation.

In the illustrated example, the implantable device 30 includes a transceiver 1118, a power source 1148, and a medical instrument 1111 that includes an electronics module 1110 and a stimulator assembly 1130. The implantable device 30 further includes a hermetically sealed, biocompatible implantable housing 1102 enclosing one or more of the components.

The electronics module 1110 can include one or more other components to provide medical device functionality. In many examples, the electronics module 1110 includes one or more components for receiving a signal and converting the signal into the stimulation signal 1115. The electronics module 1110 can further include a stimulator unit. The electronics module 1110 can generate or control delivery of the stimulation signals 1115 to the stimulator assembly 1130. In examples, the electronics module 1110 includes one or more processors (e.g., central processing units or microcontrollers) coupled to memory components (e.g., flash memory) storing instructions that when executed cause performance of an operation. In examples, the electronics module 1110 generates and monitors parameters associated with generating and delivering the stimulus (e.g., output voltage, output current, or line impedance). In examples, the electronics module 1110 generates a telemetry signal (e.g., a data signal) that includes telemetry data. The electronics module 1110 can send the telemetry signal to the wearable device 100 or store the telemetry signal in memory for later use or retrieval.

The stimulator assembly 1130 can be a component configured to provide stimulation to target tissue. In the illustrated example, the stimulator assembly 1130 is an electrode assembly that includes an array of electrode contacts disposed on a lead. The lead can be disposed proximate tissue to be stimulated. Where the system 1100 is a cochlear implant system, the stimulator assembly 1130 can be inserted into the recipient’s cochlea. The stimulator assembly 1130 can be configured to deliver stimulation signals 1115 (e.g., electrical stimulation signals) generated by the electronics module 1110 to the cochlea to cause the recipient to experience a hearing percept. In other examples, the stimulator assembly 1130 is a vibratory actuator disposed inside or outside of a housing of the implantable device 30 and configured to generate vibrations. The vibratory actuator receives the stimulation signals 1115 and, based thereon, generates a mechanical output force in the form of vibrations. The actuator can deliver the vibrations to the skull of the recipient in a manner that produces motion or vibration of the recipient’s skull, thereby causing a hearing percept by activating the hair cells in the recipient’s cochlea via cochlea fluid motion.

The transceivers 1118 can be components configured to transcutaneously receive and/or transmit a signal 1151 (e.g., a power signal and/or a data signal). The transceiver 1118 can be a collection of one or more components that form part of a transcutaneous energy or data transfer system to transfer the signal 1151 between the wearable device 100 and the implantable device 30. Various types of signal transfer, such as electromagnetic, capacitive, and inductive transfer, can be used to usably receive or transmit the signal 1151. The transceiver 1118 can include or be electrically connected to the coil 20, 1118.

As illustrated, a cover 150 is disposed around the wearable device 100. The cover 150 includes a communication coil 152 connected to wearable device with an electrical contact 155 with a wearable device electrical contact 103.

In the illustrated example, the wearable device 100 and the cover 150 lack a one or more magnets for locating the coil 152 and the implanted coil 20. In other implementations, one or more magnets can be used to align the respective coils 152, 20. The coil 152 of the wearable device 100 can be disposed in relation to (e.g., in a coaxial relationship) with a magnet set.

The power source 1148 can be one or more components configured to provide operational power to other components. The power source 1148 can be or include one or more rechargeable batteries. Power for the batteries can be received from a source and stored in the battery. The power can then be distributed to the other components as needed for operation.

As should be appreciated, while particular components are described in conjunction with FIG. 11, technology disclosed herein can be applied in any of a variety of circumstances. The above discussion is not meant to suggest that the disclosed techniques are only suitable for implementation within systems akin to that illustrated in and described with respect to FIG. 11. In general, additional configurations can be used to practice the methods and systems herein and/or some aspects described can be excluded without departing from the methods and systems disclosed herein.

### Example Device-Cochlear Implant

FIG. 12 illustrates an example cochlear implant system 1210 that can benefit from use of the technologies disclosed herein. The cochlear implant system 1210 includes an implantable component 1244 (which can correspond to implantable device 30) typically having an internal receiver/transceiver unit 1232, a stimulator unit 1220, and an elongate lead 1218. The internal receiver/transceiver unit 1232 permits the cochlear implant system 1210 to receive signals from and/or transmit signals to an external device 1250 (which can correspond to the wearable device 100). The external device 1250 can be a button sound processor worn on the head that includes sound processing components and a receiver/transceiver coil 1230 (e.g., corresponding to coil 152) disposed in a cover (e.g., cover 150, not shown in FIG. 12). Alternatively, the external device 1250 can be just a transmitter/transceiver coil in communication with a behind-the-ear device that includes the sound processing components and microphone.

The implantable component 1244 includes an internal coil 1236, and preferably, an implanted magnet fixed relative to the internal coil 1236. The magnet can be embedded in a pliable silicone or other biocompatible encapsulant, along with the internal coil 1236. Signals sent generally correspond to external sound 1213. The internal receiver/transceiver unit 1232 and the stimulator unit 1220 are hermetically sealed within a biocompatible housing, sometimes collectively referred to as a stimulator/receiver unit. Included magnets can facilitate the operational alignment of an external coil 1230 and the internal coil 1236 (e.g., via a magnetic connection), enabling the internal coil 1236 to receive power and stimulation data from the external coil 1230. The external coil 1230 is contained within an external portion. The elongate lead 1218 has a proximal end connected to the stimulator unit 1220, and a distal end 1246 implanted in a cochlea 1240 of the recipient. The elongate lead 1218 extends from stimulator unit 1220 to the cochlea 1240 through a mastoid bone 1219 of the recipient. The elongate lead 1218 is used to provide electrical stimulation to the cochlea 1240 based on the stimulation data. The stimulation data can be created based on the external sound 1213 using the sound processing components and based on sensory prosthesis settings.

In certain examples, the external coil 1230 transmits electrical signals (e.g., power and stimulation data) to the internal coil 1236 via a radio frequency (RF) link. The internal coil 1236 is typically a wire antenna coil having multiple turns of electrically insulated single-strand or multi-strand platinum or gold wire. The electrical insulation of the internal coil 1236 can be provided by a flexible silicone molding. Various types of energy transfer, such as infrared (IR), electromagnetic, capacitive and inductive transfer, can be used to transfer the power and/or data from external device to cochlear implant. While the above description has described internal and external coils being formed from insulated wire, in many cases, the internal and/or external coils can be implemented via electrically conductive traces.

### Example Device -Retinal Prosthesis

FIG. 13 illustrates a retinal prosthesis system 1301 that comprises an external device 1310 (which can correspond to the wearable device 100), a retinal prosthesis 1300 and a mobile computing device 1303. The retinal prosthesis 1300 comprises an implanted processing module 1325 (e.g., which can correspond to the implantable device 30) and a retinal prosthesis sensor-stimulator 1390 is positioned proximate the retina of a recipient. The external device 1310 and the processing module 1325 can communicate via communication coils 20, 152. As described elsewhere herein the communication coil 152 of the external device 1310 can be disposed in a cover 150, which can facilitate alignment of the coil 152 with the implanted coil 20. Signals 1351 can be transmitted using the coils 20, 152.

In an example, sensory inputs (e.g., photons entering the eye) are absorbed by a microelectronic array of the sensor-stimulator 1390 that is hybridized to a glass piece 1392 including, for example, an embedded array of microwires. The glass can have a curved surface that conforms to the inner radius of the retina. The sensor-stimulator 1390 can include a microelectronic imaging device that can be made of thin silicon containing integrated circuitry that convert the incident photons to an electronic charge.

The processing module 1325 includes an image processor 1323 that is in signal communication with the sensor-stimulator 1390 via, for example, a lead 1388 which extends through surgical incision 1389 formed in the eye wall. In other examples, processing module 1325 is in wireless communication with the sensor-stimulator 1390. The image processor 1323 processes the input into the sensor-stimulator 1390, and provides control signals back to the sensor-stimulator 1390 so the device can provide an output to the optic nerve. That said, in an alternate example, the processing is executed by a component proximate to, or integrated with, the sensor-stimulator 1390. The electric charge resulting from the conversion of the incident photons is converted to a proportional amount of electronic current which is input to a nearby retinal cell layer. The cells fire and a signal is sent to the optic nerve, thus inducing a sight perception.

The processing module 1325 can be implanted in the recipient and function by communicating with the external device 1310, such as a behind-the-ear unit, a pair of eyeglasses, etc. The external device 1310 can include an external light / image capture device (e.g., located in / on a behind-the-ear device or a pair of glasses, etc.), while, as noted above, in some examples, the sensor-stimulator 1390 captures light / images, which sensor-stimulator is implanted in the recipient.

Similar to the above examples, the retinal prosthesis system 1301 may be used in spatial regions that have at least one controllable network connected device associated therewith (e.g., located therein). As such, the processing module 1325 includes a performance monitoring engine 1327 that is configured to obtain data relating to a “sensory outcome” or “sensory performance” of the recipient of the retinal prosthesis 1300 in the spatial region. As used herein, a “sensory outcome” or “sensory performance” of the recipient of a sensory prosthesis, such as retinal prosthesis 1300, is an estimate or measure of how effectively stimulation signals delivered to the recipient represent sensor input captured from the ambient environment.

Data representing the performance of the retinal prosthesis 1300 in the spatial region is provided to the mobile computing device 1303 and analyzed by a network connected device assessment engine 1362 in view of the operational capabilities of the at least one controllable network connected device associated with the spatial region. For example, the network connected device assessment engine 1362 may determine one or more effects of the controllable network connected device on the sensory outcome of the recipient within the spatial region. The network connected device assessment engine 1362 is configured to determine one or more operational changes to the at least one controllable network connected device that are estimated to improve the sensory outcome of the recipient within the spatial region and, accordingly, initiate the one or more operational changes to the at least one controllable network connected device.

As should be appreciated, while particular uses of the technology have been illustrated and discussed above, the disclosed technology can be used with a variety of devices in accordance with many examples of the technology. The above discussion is not meant to suggest that the disclosed technology is only suitable for implementation within systems akin to that illustrated in the figures. In general, additional configurations can be used to practice the processes and systems herein and/or some aspects described can be excluded without departing from the processes and systems disclosed herein.

This disclosure described some aspects of the present technology with reference to the accompanying drawings, in which only some of the possible aspects were shown. Other aspects can, however, be embodied in many different forms and should not be construed as limited to the aspects set forth herein. Rather, these aspects were provided so that this disclosure was thorough and complete and fully conveyed the scope of the possible aspects to those skilled in the art.

As should be appreciated, the various aspects (e.g., portions, components, etc.) described with respect to the figures herein are not intended to limit the systems and processes to the particular aspects described. Accordingly, additional configurations can be used to practice the methods and systems herein and/or some aspects described can be excluded without departing from the methods and systems disclosed herein.

Similarly, where steps of a process are disclosed, those steps are described for purposes of illustrating the present methods and systems and are not intended to limit the disclosure to a particular sequence of steps. For example, the steps can be performed in differing order, two or more steps can be performed concurrently, additional steps can be performed, and disclosed steps can be excluded without departing from the present disclosure. Further, the disclosed processes can be repeated.

Although specific aspects were described herein, the scope of the technology is not limited to those specific aspects. One skilled in the art will recognize other aspects or improvements that are within the scope of the present technology. Therefore, the specific structure, acts, or media are disclosed only as illustrative aspects. The scope of the technology is defined by the following claims and any equivalents therein.

What is claimed is:

1. An apparatus comprising:
a removable cover for an ear-worn wearable device, wherein the removable cover includes a communication coil.

2. The apparatus of claim 1, wherein the cover includes:
one or more electrical contacts configured to place the communication coil in electrical communication with the ear-worn wearable device.

3. The apparatus of claim 2,
wherein the removable cover defines a concavity configured receive the ear-worn wearable device when the removable cover is coupled to the ear-worn wearable device; and
wherein the one or more electrical contacts are disposed at an inside surface of the removable cover within the concavity.

4. The apparatus of claim 2, wherein the one or more electrical contacts include at least two pins electrically coupled to the communication coil.

5. The apparatus of claim 2,
wherein the communication coil is electrically coupled to the electrical contact via a trace on a flexible printed circuit board; or
wherein the communication coil is electrically coupled to the electrical contact via a wire.

6. The apparatus of claim 1,
wherein the communication coil has a substantially circular shape.

7. The apparatus of claim 1,
wherein the communication coil is configured to be repositioned in the cover.

8. The apparatus of claims 1,
wherein the cover comprises an indented area; and
wherein the communication coil is configured to be repositioned within the indented area.

9. The apparatus of claim 1,
wherein the cover has a cover profile shape; and
wherein the communication coil has a coil shape (504) that substantially mimics the cover profile shape.

10. The apparatus of claim 1,
wherein the communication coil is at least one of a wound copper coil embedded in the cover, or
disposed on a flexible printed circuit board integrated in the cover.

11. A method comprising:
selecting a cover having a communication coil; and
coupling the cover to a wearable device.

12. The method of claim 11, further comprising:
after selecting the cover, modifying a position of the communication coil.

13. The method of claim 11, wherein selecting the cover includes:
selecting the cover from among a plurality of covers, wherein at least one other of the plurality of covers has a communication coil in a different position than the cover.

14. The method of claim 11, wherein selecting the cover includes:
selecting the cover from among a plurality of covers based on a similarity between a shape of the communication coil of the cover and a shape of an implanted coil.

15. The method of claim 11, wherein coupling the cover to the wearable device includes:
electrically coupling the communication coil to the wearable device.

16. The method of claim 15, wherein electrically coupling the communication coil to the wearable device includes:
electrically coupling a first cover electrical contact of the cover with a first wearable device electrical contact of the wearable device; and
electrically coupling a second cover electrical contact of the cover with a second wearable device electrical contact of the wearable device.

17. The method of claim 11, wherein selecting the cover having the communication coil includes:
placing a template proximate an ear of a recipient having an implanted coil;
for each respective coil of a plurality of coils of the template, measuring a connection strength between the respective coil of the template and the implanted coil; and
selecting the selected cover based on the coil of the template associated with a highest measured communication strength.

18. The method of claim 11, further comprising
attaching the wearable device to an ear of a recipient such that the communication coil is disposed proximate an implanted coil; and
establishing an inductive connection between the communication coil and the implanted coil.

19. The method of claim 18, wherein selecting the cover includes:
for each respective cover of a plurality of covers, measuring a connection strength between a respective cover communication coil of the respective cover-and the implanted coil; and
selecting the selected cover based on the selected cover having a highest connection strength.

20. The method of claim 18,
wherein the communication coil is disposed proximate the implanted coil based on a position of the communication coil in the cover.

21. A system comprising:
a wearable device; and
a cover removably coupled to the wearable device, the cover having a communication coil in electrical communication with the wearable device.

22. The system of claim 21,
wherein the cover comprises a cover electrical contact region having at least one cover electrical contact;
wherein the wearable device comprises a wearable device electrical contact region-having at least one wearable device electrical contact; and
wherein the at least one cover electrical contact and the at least one wearable device electrical contact form a connection with each other when the cover is coupled to the wearable device, thereby placing the communication coil in electrical communication with the wearable device.

23. The system of claim 22,
wherein the at least one cover electrical contact comprises a pin;
wherein the at least one wearable device electrical contact comprises a receptacle; and
wherein, when the cover is coupled to the wearable device, the pin is disposed in the receptacle.

24. The system of claim 22,
wherein the cover is configured to be removably coupled to the wearable device by a user.

25. The system of claim 22,
wherein the wearable device comprises a recessed portion configured to receive the cover.

26. The system of claim 25,
wherein the cover is substantially formfitting to an exterior surface of at least a portion of the wearable device.

27. The system of claim 22,
wherein the cover defines a concavity; and
wherein the wearable device is at least partially received in the concavity when the cover is coupled to the wearable device.

28. The system of claim 22, further comprising:
an implantable device comprising an implantable coil.

29. The system of claim 28,
wherein a communication coil shape of the communication coil matches an implantable coil shape of the implantable coil.

30. The system of claim 22,
wherein the communication coil comprises an oblong shape.
